(19) United States
(12) Patent Application Publication
(10) Pub. No.: US 2020/0017418 A1
(43) Pub. Date: Jan. 16, 2020

(54) BIOCHAR FERTILIZER

(71) Applicant: Carbon Earth LLC, Rockwood, TN (US)

(72) Inventors: Matthew M. MARTIN, Powell, TN (US); John D. BORDEN, Knoxville, TN (US); James N. RITER, Harriman, TN (US)

(21) Appl. No.: 16/507,689

(22) Filed: Jul. 10, 2019

Related U.S. Application Data
(60) Provisional application No. 62/696,125, filed on Jul. 10, 2018.

(51) Int. Cl. C05F 3/00; C05G 3/04; C05C 3/00; C05D 1/00; C05D 9/02; C05F 11/02; C05G 3/08; C05C 9/00

(52) U.S. Cl. CPC C05F 3/00; C05G 3/04; C05C 3/00; C05C 9/005; C05D 9/02; C05F 11/02; C05G 3/08; C05D 1/005

(57) ABSTRACT

In view of the foregoing, an embodiment of the disclosure provides a process of producing a granulated fertilizer and a granulated fertilizer made by the process. The process includes the steps of:
a) forming a dry mixture of:
   i) about 10% to about 45% by weight poultry litter;
   ii) about 20% to about 50% by weight ammonium sulfate;
   iii) about 0% to about 30% by weight leonardite;
   iv) about 0% to about 25% by weight biochar;
   v) about 5% to about 25% by weight potassium sulfate; and
   vi) about 0% to about 10% by weight ferrous sulfate;
b) granulating the dry mixture in a granulator to form a granulated dry mixture;
c) adding a binding agent to the granulated dry mixture to form a bound-granulated product; and
d) drying the bound-granulated product to form the granulated fertilizer.

### RELATED APPLICATION

This application claims priority to provisional application No. 62/696,125, filed Jul. 10, 2018, now pending.

### TECHNICAL FIELD

This disclosure relates generally to a value-added granulated biochar fertilizer and a process for producing the same. In particular, the disclosure relates to a value-added granulated fertilizer and a process for producing the same from fresh poultry litter and biochar resulting in a biochar fertilizer having improved properties for handling and use.

### BACKGROUND AND SUMMARY

Approximately nine (9) billion broilers in the United States produce 13.9 million tons of poultry litter (“PL”) as a waste product annually. Landfill of PL is restricted due to the perceived risk of phosphorus (“P”) extraction from the PL, accordingly, the potential liability and disposal costs are tremendous. Over-application of PL and runoff water increases total phosphorus (“TP”) and dissolved reactive P (“DRP”) concentrations in runoff water. DRP is considered one of the predominant, non-point source pollutants in freshwater systems resulting in algal bloom, low dissolved oxygen in the water, fish kill and generally undesirable water conditions.

Given some modification, environmentally stable PL can be an excellent fertilizer source useful on row crop production areas that traditionally operate on P and nitrogen (“N”) deficient soils. Studies also show restorative qualities of using PL on precision leveled soils and found positive influences on soil properties, such as bulk density. There is therefore a need for a process and composition containing PL that is environmentally stable and provides the required soil nutrients.

Fresh PL and biochar are bulky, smelly, have low nutrient concentrations, have irregular shapes, and require special equipment for fertilizer application. Biochar lacks density, is very dusty, and does not flow through standard equipment due to shape. Pelletizing PL is a common industrial practice to change products into a desirable end-form, but the cost of production and end-user acceptance limit its commercial use. However, granulation of PL and biochar represents an opportunity to enhance the commercial acceptance of the products.

It is therefore desirable to provide a value-added granulated fertilizer produced by a granulation process that is faster and cheaper than traditional PL pelletizing techniques and results in a N-fortified PL and biochar granular fertilizer.

It is also desirable to provide a value-added granulated PL and biochar fertilizer that creates a valuable commercial alternative for biochar and PL waste products, addresses concerns over ever increasing fertilizer prices, and addresses public concerns associated with nutrient loading via runoff into freshwater systems.

It is further desirable to provide a value-added granulated fertilizer and process of producing the same that provide significant costs savings while combining the nutrients from PL with biochar.

It is still further desirable to provide a process of producing a value-added granulated fertilizer that significantly increases bulk density of fresh PL and biochar, thus making the granulated fertilizer more economical to transport, store, and apply, along with reducing fines (dust) and odor associated with PL.

It is yet further desirable to provide a value-added granulated fertilizer produced by a granulation process that increases water soluble P over fresh PL, thereby making more P readily available to the plant.

It is yet further desirable to provide a value-added granulated fertilizer and process of producing the same having overall P runoff water loads that are less than commercial fertilizers (triple superphosphate) that have higher water-soluble P.

It is yet further desirable to provide a value-added granulated fertilizer and process of producing the same having lower levels of soluble P allowing a producer to apply more fertilizer than higher water-soluble P sources.

It is yet further desirable to provide a value-added granulated fertilizer and process of producing the same that utilizes PL and biochar, which have slow mineralizable N and P, and thereby provide a slow release fertilizer source over a growing season.

It is yet further desirable to provide a value-added granulated fertilizer and process of producing the same that utilizes granulated PL and biochar that offer micronutrient components, such as fortified with iron for lawns.

It is yet further desirable to provide a value-added granulated fertilizer and process of producing the same capable of utilizing different binding agents to make the granules stronger so they resist breakdown via friction and force, thus resulting in less dust and fines when the granulated fertilizer reaches the end consumer which allows for more even application of the fertilizer.

In view of the foregoing, an embodiment of the disclosure provides a process of producing a granulated fertilizer and a granulated fertilizer made by the process. The process includes the steps of:
a) forming a dry mixture of:
   i) about 10% to about 50% by weight poultry litter;
   ii) about 20% to about 50% by weight ammonium sulfate;
   iii) about 0% to about 30% by weight leonardite;
   iv) about 0% to about 25% by weight biochar;
   v) about 5% to about 25% by weight potassium sulfate; and
   vi) about 0% to about 10% by weight ferrous sulfate;
b) granulating the dry mixture in a pin mixer to form a granulated dry mixture;
c) adding a binding agent to the granulated dry mixture to form a bound-granulated product; and
d) drying the bound-granulated product to form the granulated fertilizer.

In another embodiment, the disclosure provides a value-added-granulated fertilizer. The value-added-granulated fertilizer includes:
a) about 35 to about 44% by weight poultry litter;
b) about 30 to about 40% by weight ammonium sulfate;
c) about 0.5 to about 1.5% by weight biochar;
d) about 0.5 to about 1.5% by weight leonardite.
e) about 5.0 to about 12.0% by weight potassium sulfate;
f) about 2.0 to about 6.0% by weight ferrous sulfate; and
g) a binding agent;

wherein the weight percentages are based on the weight sum of components (a)-(f).

In some embodiments, the process further includes the steps of:
a) grinding the poultry litter;
b) passing the ground poultry litter through an about 1 mm screen; and
c) mixing the ground poultry litter in a ribbon blender.

In other embodiments, the step of forming the dry mixture further includes the step of mixing the dry mixture in a ribbon blender for about thirty minutes.

In some embodiments, the step of forming the dry mixture further includes the step of forming the dry mixture from:
a) about 35 to about 44% by weight poultry litter;
b) about 30 to about 40% by weight ammonium sulfate;
c) about 0.5 to about 1.5% by weight biochar;
d) about 0.5 to about 1.5% by weight leonardite.
e) about 5.0 to about 12.0% by weight potassium sulfate; and
f) about 2.0 to about 6.0% by weight ferrous sulfate

In some embodiments, the step of granulating the dry mixture further includes the step of feeding the dry mixture into a pin mixer granulator running at about 1200 to about 1600 rotations per minute using a vibrating screw feeder at a rate of about 1.5 to about 2.5 kg dry mixture per minute.

In other embodiments, the step of adding the binding agent further includes the step of forming a liquid binding agent mixture of:
a) about 70% to about 100% by weight water;
b) about 0% to about 15% by weight lignosulfonate; and
c) about 0% to about 15% by weight urea soil and plant stimulant containing 6% by weight humic acid and 3% by weight sea kelp extract.

In still other embodiments, the step of forming the liquid binding agent mixture further includes the step of forming the liquid binding agent mixture of about 70% by weight water and about 15% by weight lignosulfonate or about 15% by weight urea soil and plant stimulant containing 6% by weight humic acid and 3% by weight sea kelp extract.

In some embodiments, a step of applying the liquid binding agent mixture to the granulated dry mixture includes the use of a spray nozzle set at about 0.15 to about 0.35 MPa to form the bound-granulated product.

In some embodiments, the step of drying the bound-granulated product further includes the step of drying the bound-granulated product at about 180° C. to about 200° C. until an average water concentration of the granulated fertilizer is about 100 to about 140 g of water per kilogram of the granulated fertilizer. In other embodiments, the step of drying the bound-granulated product further includes the step of drying the bound-granulated product at about 180° C. to about 200° C. for about 3 to about 4 hours.

An advantage of the disclosed embodiments is that the granulated fertilizer containing the poultry litter and biochar aids the flowability, storage, and spreading of the fertilizer, while value-added plant nutrient ingredients to provide an environmentally safer fertilizer than synthetic inputs, fresh poultry litter, municipal biosolids and/or many commercially available products commonly used in urban and agricultural systems. The binding agents change the water soluble phosphorus and nitrogen concentrations into fertilizer granules that reduce fines and dust. The biochar reduces nitrogen losses via leaching and denitrification through its unique ability to store and house nitrogen, while poultry litter decreases water soluble and total phosphorus concentrations in runoff water for environmental protection.

Another advantage of the disclosed embodiments, is an increased rate of production and a decreased cost of production which allows specific binding agents to be agglomerated for ease in handling, storage and application. The binding agents also allow value-added materials to be easily incorporated to change the structural and nutrient release characteristics of the granulated fertilizer that impact plant nutrient uptake and reduce environmental nutrient loss. Other advantages and features will be apparent from the following description and FIGURE.

### BRIEF DESCRIPTION OF THE DRAWING

FIG. 1 is a schematic drawing of a process for producing a value-added-granulated fertilizer product according to an embodiment of the disclosure.

### DETAILED DESCRIPTION OF THE DISCLOSED EMBODIMENTS

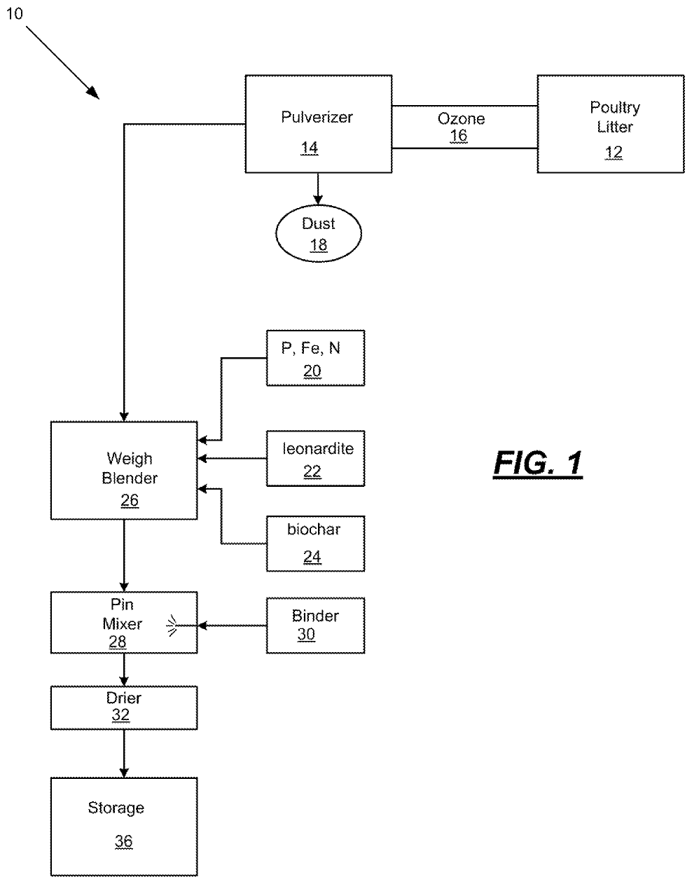

In general, in a first aspect, the invention relates to a process of producing a value-added granulated fertilizer. With reference to FIG. 1, the process 10 includes the steps of forming a dry mixture, granulating the dry mixture in a granulator to form a granulated dry mixture, adding a binding agent to the granulated dry mixture to form a bound-granulated product, and drying the bound-granulated product to form the granulated fertilizer.

A primary component of the granulated fertilizer described herein is poultry litter 12. In some embodiments, the process includes the step of grinding the poultry litter in a pulverizer 14 and passing the ground poultry liter through a 0.5 to about 1.5 mm screen, such as a 1 mm screen to remove dust 18. The poultry litter may also be passed through a blender and an ozone system 16 to clean the poultry litter of any biologically active bacteria or fungi and/or remove offensive odors. The dry mixture may contain from about 10% to about 50% by weight poultry litter, such as about 35 to about 44% by weight poultry litter,

Another component of the dry mixture is an inorganic fertilizer 20 that provides one or more of P, Fe and N to the dry mixture. The inorganic fertilizer may be selected from the group consisting of ammonium sulfate, potassium sulfate, ammonium nitrate, potassium nitrate, ferrous sulfate, ferric nitrate, magnesium sulfate, and mixtures thereof. A particularly suitable inorganic fertilizer component includes a mixture of ammonium sulfate potassium sulfate, and ferrous sulfate. In the process and compositions described herein, the dry mixture may contain from about 20% to about 50% by weight ammonium sulfate, such as about 30 to about 40% by weight ammonium sulfate; from about 5% to about 25% by weight potassium sulfate, such as from about 5% to about 12% by weight potassium sulfate; and from about 0% to about 10% by weight ferrous sulfate, such as from about 2.0 to about 6.0% by weight ferrous sulfate. The nitrogen concentration of the granulated fertilizer may be increased by being blended with a homogeneous granular fertilizer containing urea and ammonium sulfate. A 7.3:1 N to S ratio is optimal for grain crop fertilization. By combining urea and ammonium sulfate into one particle, N and S uptake by plant roots is increased compared to physical blends.

Carbon sources are also included in the dry mixture and may be selected from leonardite 22, biochar 24, and mixtures thereof. In some embodiments, the dry mixture includes from about 0% to about 30% by weight leonardite, such as from about 0.5% to about 1.5% by weight leonardite, and from about 0% to about 25% by weight biochar, such as from about 0.5 to about 1.5% by weight biochar. Like the PL described above, the biochar may also be ground and passed through a 0.5 to about 1.5 mm screen, such as a 1 mm screen.

According to the process, the fertilizer components described above are blended together in a weighing blender 26 to provide a dry mixture of the components. Additionally, the step of blending the fertilizer components together may also include the step of mixing the fertilizer components in a rotary mixer for approximately thirty minutes to provide a dry mixture of the foregoing fertilizer components. In some embodiments, the fertilizer components may be mixed in a feed mill mixer or a ribbon blender.

In the process of producing the value-added granulated fertilizer, the step of granulating the dry mixture may further include the step of feeding the dry mixture into a disc granulator, a drum granulator or a pin mixer granulator 28 running at about 1200 to about 1600 rotations per minute using a vibrating screw feeder at a rate of about 1.5 to about 2.5 kg dry mixture per minute. The resulting product from the granulator is a granulated dry mixture of the beforementioned fertilizer components.

Once the granulated dry mixture is formed, a binding agent 30 is added to the granulated dry mixture to form a bound-granulated product. The step of adding the binding agent to the granulated dry mixture my include the step of forming a liquid binding agent mixture of about 70% to about 100% by weight water, about 0% to about 15% by weight lignosulfonate, and about 0% to about 15% by weight urea soil and plant stimulant containing 6% by weight humic acid and 3% by weight sea kelp extract. In some embodiments, the liquid binding agent mixture includes from about 60% to about 80% by weight water, from about 10% to about 20% by weight lignosulfonate, and from 10% to about 20% by weight urea soil and plant stimulant containing 6% by weight humic acid and 3% by weight sea kelp extract. The liquid binding agent mixture may be applied to the granulated dry mixture via a spray nozzle set at about 0.15 to about 0.35 MPa to form the bound-granulated product.

Once the binding agent is thoroughly mixed with the granulated dry mixture to form the bound-granulated product, the bound-granulated product is dried in a drier 32 at about 180° C. to about 200° C. until an average water concentration of the bound-granulated product is about 100 to about 140 g of water per kilogram of the bound-granulated product. In some embodiments, the bound-granulated product is dried about 180° C. to about 200° C. for about 3 to about 4 hours to provide the value-added, granulated biochar fertilizer which is then stored in a storage bin 36 for bagging and bulk transportation.

The value-added granulated fertilizer disclosed herein is produced using an agglomeration process including a pin mixer granulator 28 that results in small dense spherical particles that look similar to traditional fertilizer granules. The fertilizer particles are about three (3) mm in size.

The granulated fertilizer formulated with PL and biochar aid in flowability, storage, spreading, and settling, and the value-added ingredients including, but not limited to, macronutrients (P, N and/or potassium) and/or micronutrients (iron, calcium, magnesium, zinc, copper and/or boron) provide an environmentally safer fertilizer than fresh PL, biochar, or many commercially available products commonly used in urban and agricultural systems. The granulated fertilizer includes N, such as from urea and/or ammonium sulfate, added to the formulations of the granulated fertilizer during the production process to increase the N concentration, thereby improving fertilizer economics and efficiencies. The binding agent that is added to the granulated fertilizer during the production process provides an increased granule resistance to friction and increased overall granule strength. The binding agent may also decrease the water solubility of P and N in the fertilizer and reduce fines and dust. Overall, the granulation process for producing the value-added granulated fertilizer disclosed herein changes fresh PL and biochar into forms that are suitable for homeowner and agricultural uses, while disposing of expensive waste streams in an environmentally safe manner.

It will be appreciated that the process for producing the value-added granulated fertilizer disclosed herein uses centrifugal force and the addition of a binding agent to successfully agglomerate the powdery components of the dry mixture for ease in transporting, storage and application. During the granulation process, value-added materials can be easily incorporated into the dry mixture to change structural characteristics and nutrient release characteristics that ultimately impact plant nutrient uptake and reduces environmental nutrient loss. The granulated fertilizer creates a valuable commercial alternative for two (2) waste products (i.e., poultry litter and biochar), addresses concerns over ever increasing fertilizer prices, and reduce public concerns associated with nutrient loading via runoff into freshwater bodies.

The nitrogen concentration of the granulated fertilizer is increased by being blended with a homogeneous granular fertilizer containing urea and ammonium sulfate. A 7.3:1 N to S ratio is optimal for grain crop fertilization. By combining urea and ammonium sulfate into one particle, N and S uptake by plant roots is increased compared to physical blends.

The following examples illustrate various aspects of the disclosed embodiments and are not intended to limit the disclosed embodiments.

### EXAMPLE

### Manufacturing Materials and Methods

Poultry Litter (PL) was collected from the Charlie's Compost in Calhoun Ky. The bedding material consisted of 48.9% rice (Oryza sativa) hulls and 48.9% wood shavings, feces from six (6) flocks of production broilers, and contained 1.2% biochar as a litter treatment additive. Bird diet and environmental conditions were standard as prescribed by Perdue Farms. To foster granulation, collected litter was ground until it passed through a 1 mm screen and thoroughly mixed using a ½ cubic yard ribbon blender.

PL, biochar, ammonium sulfate (21% N), leonardite, potassium sulfate, and ferrous sulfate were blended in the ribbon blender and were then weighed in appropriate ratios as previously stated. The PL, biochar and additives mixture were fed into a pin mixer granulator running at about 1400 rotations per minute (rpm) using a vibrating screw feeder at a rate of approximately 2.09 kg mixed dry product per minute. Binding agents were added through a nozzle set at approximately 0.276 MPa. The binding agents were tap water, lignosulfonate, and/or urea soil and plant stimulant containing 6% by weight humic acid and 3% by weight sea kelp extract. Granule samples used for evaluation were collected only after representative granules were produced. After granulation, the bound-granulated product was dried at about 191° C. for about 3.5 hours until average water concentration was reduced to about 120 g water per kg. The components of the value-added fertilizer are shown in the following tables.

TABLE 1
Dry Mixture

| Component | Amount by weight |
|---|---|
| Poultry litter | 44 |
| Ammonium sulfate | 40 |
| Biochar | 1.2 |
| Leonardite | 1.0 |
| Potassium sulfate | 9.8 |
| Ferrous sulfate | 4.0 |
| Total | 100 |

TABLE 2
Binding Agent

| Component | Amount by weight |
|---|---|
| Water | 70 |
| Lignosulfonate | 15 |
| Urea soil and plant stimulant containing 6% by | 15 |
| weight humic acid and 3% by weight sea kelp | |
| extract | |

### Granule Physical Characteristics

The granulated fertilizers ranged in loose bulk density from about 0.44 to about 0.59 g/cm³; which was lower than commercially available urea and triple superphosphate (“TSP”) fertilizers that have bulk densities of 0.76 and 1.09 g/cm³, respectively. Treatment of the granules with lignosulfonate urea soil and plant stimulant containing 6% by weight humic acid and 3% by weight sea kelp extract produced heavier granules than treatment with water. Denser products allow for more weight to be shipped per volume, reducing shipping cost per kilogram of N or P.

In order to measure stress incurred during storage, transport, and application, an attrition test was used. The attrition test measured the strength of granules when exposed to friction due to shaking. Fines produced due to attrition may cause uneven spreading during application and are susceptible to dust formation during windy conditions, and likely mineralize nutrients at different rates than larger particles. The various binding agents interacted with the biochar component to produce granules with varying levels of deterrence to attrition.

While the compositions and processes have been described with a certain degree of particularity, it is to be noted that many modifications may be made in the details of the compositions and processes without departing from the spirit and scope of this disclosure. It is understood that the compositions and processes are not limited to the embodiments set forth herein for purposes of exemplification.

What is claimed is:

1. A process of producing a granulated fertilizer, the process comprising the steps of:
a) forming a dry mixture of:
i) about 10% to about 50% by weight poultry litter;
ii) about 20% to about 50% by weight ammonium sulfate;
iii) about 0% to about 30% by weight leonardite;
iv) about 0% to about 25% by weight biochar;
v) about 5% to about 25% by weight potassium sulfate; and
vi) about 0% to about 10% by weight ferrous sulfate;
b) granulating the dry mixture in a granulator to form a granulated dry mixture;
c) adding a binding agent to the granulated dry mixture to form a bound-granulated product; and
d) drying the bound-granulated product to form the granulated fertilizer.

2. The process of claim 1, further comprising the steps of:
a) grinding the poultry litter;
b) passing the ground poultry litter through an about 1 mm screen; and
c) mixing the ground poultry litter in a ribbon blender.

3. The process of claim 1, wherein the step of forming the dry mixture further comprises the step of mixing the dry mixture in a ribbon blender for about thirty minutes.

4. The process of claim 1, wherein the step of forming the dry mixture further comprises the step of forming the dry mixture from:
a) about 35 to about 44% by weight poultry litter;
b) about 30 to about 40% by weight ammonium sulfate;
c) about 0.5 to about 1.5% by weight biochar;
d) about 0.5 to about 1.5% by weight leonardite.
e) about 5.0 to about 12.0% by weight potassium sulfate; and
f) about 2.0 to about 6.0% by weight ferrous sulfate

5. The process of claim 1, wherein the step of granulating the dry mixture further comprises the step of feeding the dry mixture into a pin mixer granulator running at about 1200 to about 1600 rotations per minute using a vibrating screw feeder at a rate of about 1.5 to about 2.5 kg dry mixture per minute.

6. The process of claim 1, wherein the step of adding the binding agent further comprises the step of forming a liquid binding agent mixture of:
a) about 70% to about 100% by weight water;
b) about 0% to about 15% by weight lignosulfonate; and
c) about 0% to about 15% by weight urea soil and plant stimulant containing 6% by weight humic acid and 3% by weight sea kelp extract.

7. The process of claim 6, wherein the step of forming the liquid binding agent mixture further comprises the step of forming the liquid binding agent mixture of about 70% by weight water and about 15% by weight lignosulfonate or about 15% by weight urea soil and plant stimulant containing 6% by weight humic acid and 3% by weight sea kelp extract.

8. The process of claim 6, further comprising a step of applying the liquid binding agent mixture to the granulated dry mixture via a spray nozzle set at about 0.15 to about 0.35 MPa to form the bound-granulated product.

9. The process of claim 1, wherein the step of drying the bound-granulated product further comprises the step of drying the bound-granulated product at about 180° C. to about 200° C. until an average water concentration of the granulated fertilizer is about 100 to about 140 g of water per kilogram of the granulated fertilizer.

10. The process of claim 1, wherein the step of drying the bound-granulated product further comprises the step of drying the bound-granulated product at about 180° C. to about 200° C. for about 3 to about 4 hours.

11. A value-added-granulated fertilizer, comprising:
a) about 35 to about 44% by weight poultry litter;
b) about 30 to about 40% by weight ammonium sulfate;
c) about 0.5 to about 1.5% by weight biochar;
d) about 0.5 to about 1.5% by weight leonardite.
e) about 5.0 to about 12.0% by weight potassium sulfate;
f) about 2.0 to about 6.0% by weight ferrous sulfate; and
g) a binding agent;
wherein the weight percentages are based on the weight sum of components (a)-(f).

12. The value-added-granulated fertilizer of claim 11, wherein the binding agent comprises a liquid binding agent mixture of:
a) about 70% to about 100% by weight water;
b) about 0% to about 15% by weight lignosulfonate; and
c) about 0% to about 15% by weight of a urea soil and plant stimulant containing 6% by weight humic acid and 3% by weight sea kelp extract.
